(19) United States
(12) Patent Application Publication
(10) Pub. No.: US 2012/0278814 A1
(43) Pub. Date: Nov. 1, 2012

(54) Shared Drivers in Multi-Core Processor

(76) Inventors: Sujith Shivalingappa, Bangalore (IN); Purushotam Kumar, Bangalore (IN)

(21) Appl. No.: 13/095,423

(22) Filed: Apr. 27, 2011

(51) Int. Cl. G06F 9/54

(52) U.S. Cl. 719/312

(57) ABSTRACT

A method for sharing a resource between multiple processors within a single integrated circuit that share a memory is described. A command structure is built in shared memory by a client on a first processor for a service offered by a second processor, wherein the first processor and second processor have access to the shared memory. Attention from the second processor is requested. The command in shared memory is decoded by a host on the second processor in response to the request for attention. The service is performed on the second processor according to the command. The client on the first processor is notified when the service is complete.

### FIELD OF THE INVENTION

This invention generally relates to multiple central processing units on a single integrated circuit, and more particularly to sharing peripherals and other resources between multiple processing units on a chip.

### BACKGROUND OF THE INVENTION

With ever increasing need for higher computational power, multiple central processing units (CPUs), also referred to as a cores, are being integrated to form a single system on a chip (SoC). In such SoCs, each of the cores could be different (i.e. a heterogeneous system) and could host different operating system but share the same memory and peripherals. When two or more cores share a peripheral or other resource, each core requires a driver to interface with the resource.

### BRIEF DESCRIPTION OF THE DRAWINGS

Particular embodiments in accordance with the invention will now be described, by way of example only, and with reference to the accompanying drawings:

FIG. 1 illustrates a prior art system on a chip (SoC);

FIGS. 2 and 3 illustrate embodiments of the invention on an SoC;

FIGS. 4 and 5 are a sequence diagram depicting client/host data flow; and

FIG. 6 is a block diagram of an SoC that may include an embodiment of the invention.

Other features of the present embodiments will be apparent from the accompanying drawings and from the detailed description that follows.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Efficient methods to share peripheral (s)/resources between cores in a multi-core CPU with shared memory will be described herein. An embodiment of the invention may include an efficient method to use services of device drivers hosted on a remote processor, by one or more clients running on different processors in multi-processor shared memory architecture in a single package.

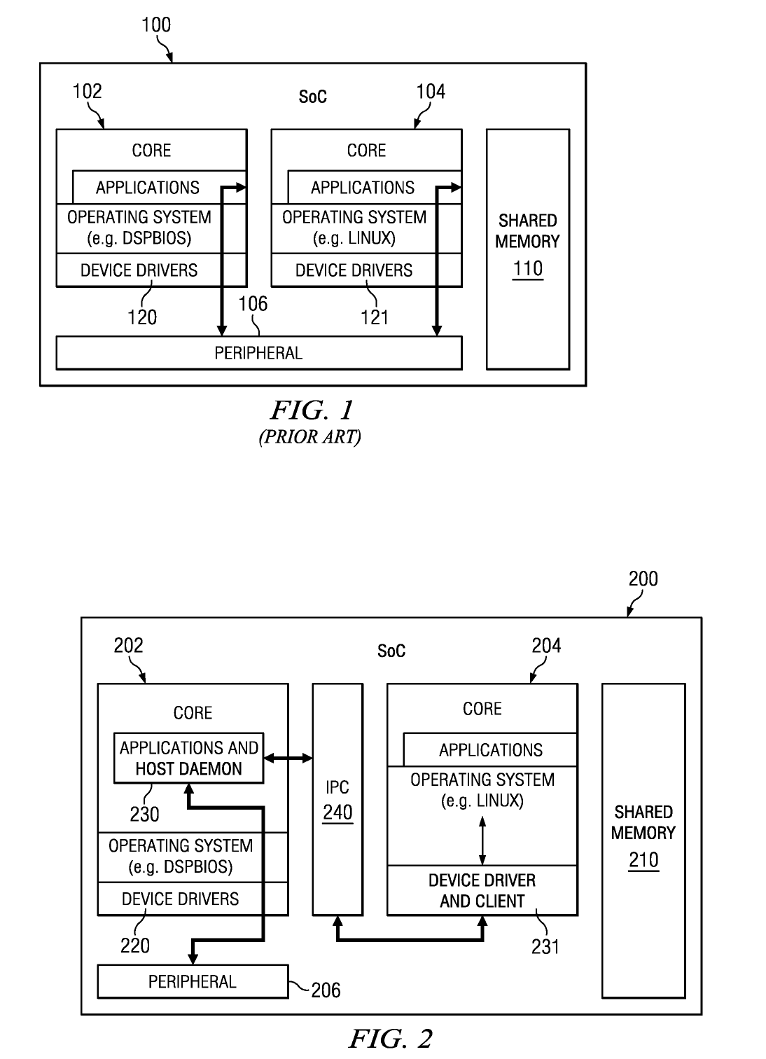

FIG. 1 illustrates a prior art system on a chip (SoC) 100. With ever increasing need for higher computational power, multiple central processing units (CPUs), also referred to as a cores, are being integrated to form a single system on a chip (SoC). In such SoCs, each of the cores 102, 104 could be different (i.e. a heterogeneous system) and could host different operating system but share same memory 110 and peripherals 106, for example. Applications access these peripherals through a set of routines referred as device drivers. These drivers could be a part of the operating system or could be a part of applications.

It is now becoming apparent that in an SoC, if multiple cores are to use the same peripheral, a method for sharing drivers is needed. For example, in one SoC, there may be device drivers running on one core, such as a digital signal processor (DSP) 104 hosting an operating system, such as DSP BIOS, and another core, such as a reduced instruction set computer (RISC) 106, hosting different operating system, such as Linux.

One could write drivers 120, 121 on all the cores and for possibly different operating systems; however, there are several drawbacks in this approach. For example, performance may be compromised, since for some of the streaming peripherals it might not be possible to re-program the peripheral to work with different core without breaking the protocol. For example, multichannel audio serial ports (McASP) and digital to analog converters (DACs) such as AlC23, video display controllers, image capture devices, etc. Sub-optimal use of peripherals may result since each driver would require exclusive access to the peripheral, which could be achieved via a hardware lock, in addition to re-programming the device configuration every time the peripheral is used by a different core. Increased latency may occur while acquiring mutual exclusiveness to access to the peripheral and could increase latency to service an 10 request in addition to time taken to re-program the peripheral. A significant effort is required to re-write drivers for all cores possibly under different operating systems to acquire exclusive access to the peripheral and re-program it for each use. With each core having its own device driver, there may be increased requirement on the memory for both non-volatile and volatile memory.

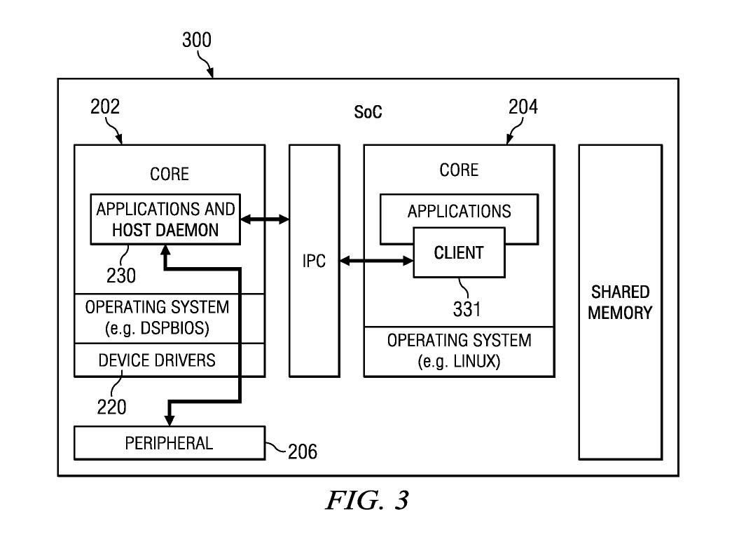

FIGS. 2 and 3 illustrate embodiments of the invention on an SoC 200, 300. The basic idea is to have a driver 220 running on one core, such as core 202, along with a daemon 230, referred as a host in this document, and to have each of the other cores run a dummy driver 231, referred to as a client in this document that would request the host to perform required operations. FIG. 2 illustrates a client/agent 231 residing as a kernel component (device driver). FIG. 3 illustrates a client/agent 331 residing as an application component.

A thin host 230 may be hosted on core, such as core 202, that decodes the commands sent by clients/agents hosted on the other cores via inter-processor communication (IPC) mechanism 240 and executes the command. Typically, this may be done with a call to an associated device driver. Inter-process communication is a set of methods for the exchange of data among multiple threads in one or more processes. Processes may be running on one or more processor connected by a communication channel. The communication channel may be in the form of a network on the chip (NoC), or may use messages passed via a system interconnect bus, for example. While host daemon 230 is illustrated to be on core 202, there may also be host daemons on core 204 that support requests for a client/agent on host 202 for use of drivers that are particular to core 204.

A host is a software daemon that waits for a command from a remote client/agent. On reception of the command the host daemon may perform the following:

decode the command and identify the driver in the host core that could service this command;

call the device driver, with the parameters provided by the remote client/agent in the context of a task/thread; and

let the remote client/agent know status of command.

A client/agent is a driver/software daemon, running on a core that may require services of a device driver running on a different core. A client/agent may perform the following:

a client/agent receives a command from the application (hosted on the same core) via operating system defined interfaces;

formulate the command as required by host (with no memory to memory copy);

notify the host via IPC;

wait for completion of the command; and

return the status back to application.

As illustrated in FIGS. 2 and 3, the client may either reside as device driver or as an application thread that may service other applications in the system.

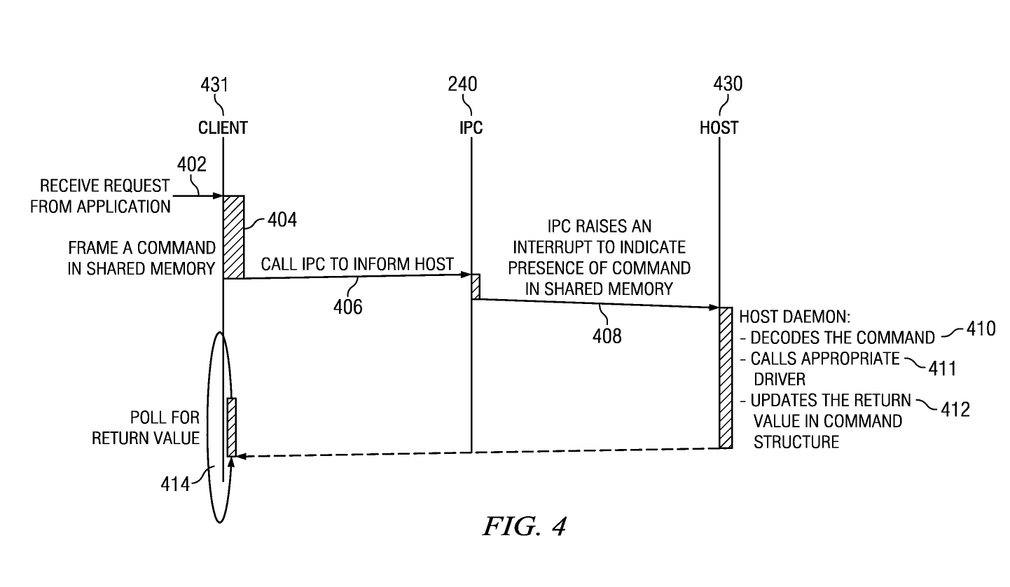

FIG. 4 is a sequence diagram depicting client/host data flow, in which an interrupt is used on the host side, while the client waits for a response. FIG. 4 is illustrative of a client/agent and host according to either FIG. 2 or FIG. 3. Client/agent 431 may be located on one core of an SoC, while host daemon 430 is located on another core of the SoC. IPC 240 provides inter-processor communication between the cores, as described in more detail above.

A client 431 receives a driver request 402 from an application to use the device driver on the host side. The application is being executed on the same core that executes client 431.

Client 431 frames a command 404 in the shared memory, such as shared memory 210 and then uses IPC 240 to inform the host 406 about the request. The client then poll/waits 414 for the host to update a member of a command structure with status of the command request after the command has been executed. The command structure in shared memory is known to both client 431 and host daemon 430 and includes a description of the requested driver operation and may include pointers to a buffer for passing data, or may contain an allocation of memory for passing data, to be sent or received by the driver in response to the driver request. The command structure may include other status and control bits for use by the client and host daemon to coordinate their actions.

IPC 240 generates an interrupt 408 on the host core to indicate the presence of a request command in shared memory. Host 430 then decodes 410 the command in shared memory and calls 411 the appropriate driver.

In this example, the host does not inform IPC on completion of the request. Instead, the host updates 412 one of the members of the command structure in shared memory 210 to let the client know the status of the command. This approach reduces the number of interrupts in the IPC by enforcing a rule that client/agent is to poll 414 on the status field of command structure after a defined timeout. In this manner, the time delay for a command execution is reduced, and can easily support data intensive operations such as video display/captures/etc.

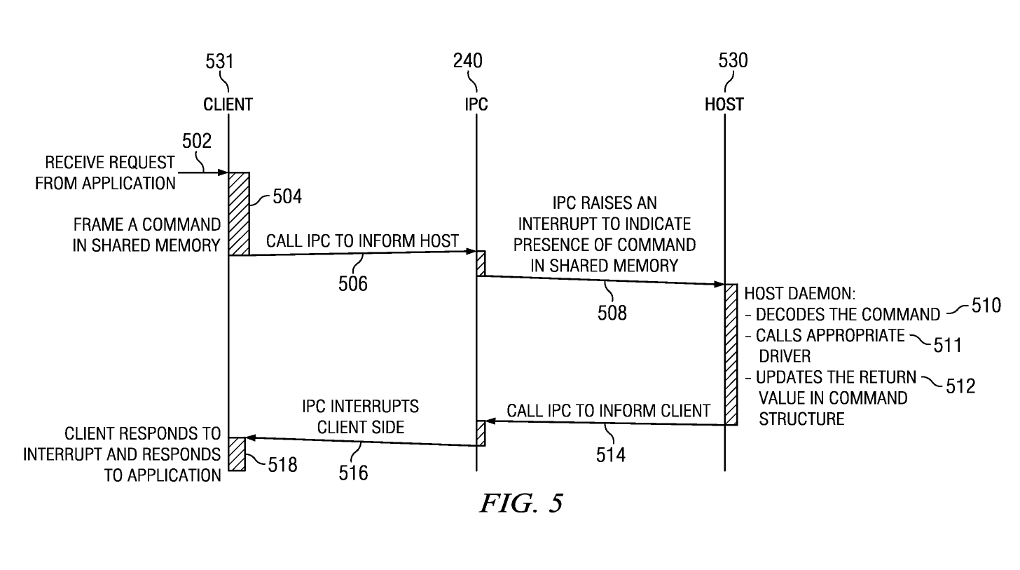

FIG. 5 is a sequence diagram depicting client/host data flow, in which an interrupt is used on the host side and on the client side, so that the client does not need to wait for a response. Client 531 receives 502 a driver request from an application to use the device driver on the host side. Client 531 then frames a command 504 in the shared memory, and calls 506 IPC to let the host know about the request.

Client 531 waits for the occurrence of interrupt from the IPC module, and therefore does not expend resource in polling.

IPC generates an interrupt 508 on the host side, indicating the presence of a request in shared memory 210. The host daemon 530 decodes 510 the command and calls 511 the appropriate driver. The host daemon calls 514 IPC on completion of the request. Host daemon 530 may also update 512 a return value in the command structure in shared memory; however, client 531 is not polling on this value.

IPC 240 raises an interrupt 516 in the client side, informing client/agent 531 that the driver request is completed. Client 531 updates 518 the application on the status of the driver request.

This approach may reduce loading on shared memory in scenarios where memory access should be minimized, since polling of a status bit in the command structure is not needed. This approach provides asynchronous capability and decreases foot print of the final application.

Table 1 contains an example of pseudo code for a typical command structure that may be used to communicate a command from client to a host and to convey results of command back to client from host.

TABLE 1
command structure pseudo code

typedef struct proxyServerCommand_t
{

| | |
|---|---|
| unsigned int | cmdType; |

/**< [IN] Specifies the command type. Could be IO Request, Control
Request, simple command, composite commands, etc...

This will be updated by Clients and consumed by Host*/

| | |
|---|---|
| unsigned int | cmd; |

/**< [IN] Specifies the command. Including identification of driver, etc...

This will be updated by Clients and consumed by Host*/

| | |
|---|---|
| int | returnValue; |

/**< [OUT] Used by host to inform Clients on status of command

This will be updated by Host to let Clients know on the status of
Command */

<Type determined by cmd and cmdType> argument1;

/**< [IN] Arguments required device drivers on host side, depending on
cmd, cmdType and driver

This will be updated by Clients and consumed by Host */

<Type determined by cmd and cmdType> argument2;

/**< [IN] Arguments required device drivers on host side, depending on
cmd, cmdType and driver
This will be updated by Clients and consumed by Host */

<Type determined by cmd and cmdType> argumentN;

/**< [IN] Arguments required device drivers on host side, depending on
cmd, cmdType and driver
This will be updated by Clients and consumed by Host */

| | |
|---|---|
| unsigned int | clientIdentifier; |

/**< [IN] Specifies the identifier to identify client.

This will be updated by Clients and consumed by Host. This
will be used by Host in case approach 2 is used or to implement
secured access*/

} proxyServerCommand;

Applications executed on an SoC with an embodiment of the invention do not need to be aware of underlying hardware, such as shared peripherals between multiple cores. Peripherals/resources that are accessible to only one core, because of physical restrictions or because of driver availability, may never the less be accessible by any IPC interconnected core within the SoC.

Localization of hardware access to a peripheral may simplify the design of the SoC. If multiple processors were to access the peripheral, extra mechanism may be needed to ensure exclusive access in addition to re-programming of the peripheral.

No memory to memory copying of data is required between a client and host. Instead, a pointer to data is moved between host and clients/agents.

Priorities may be assigned to different core/type of commands. Commands may then be processed in different threads that have different priorities, hence prioritizing commands from cores/commands.

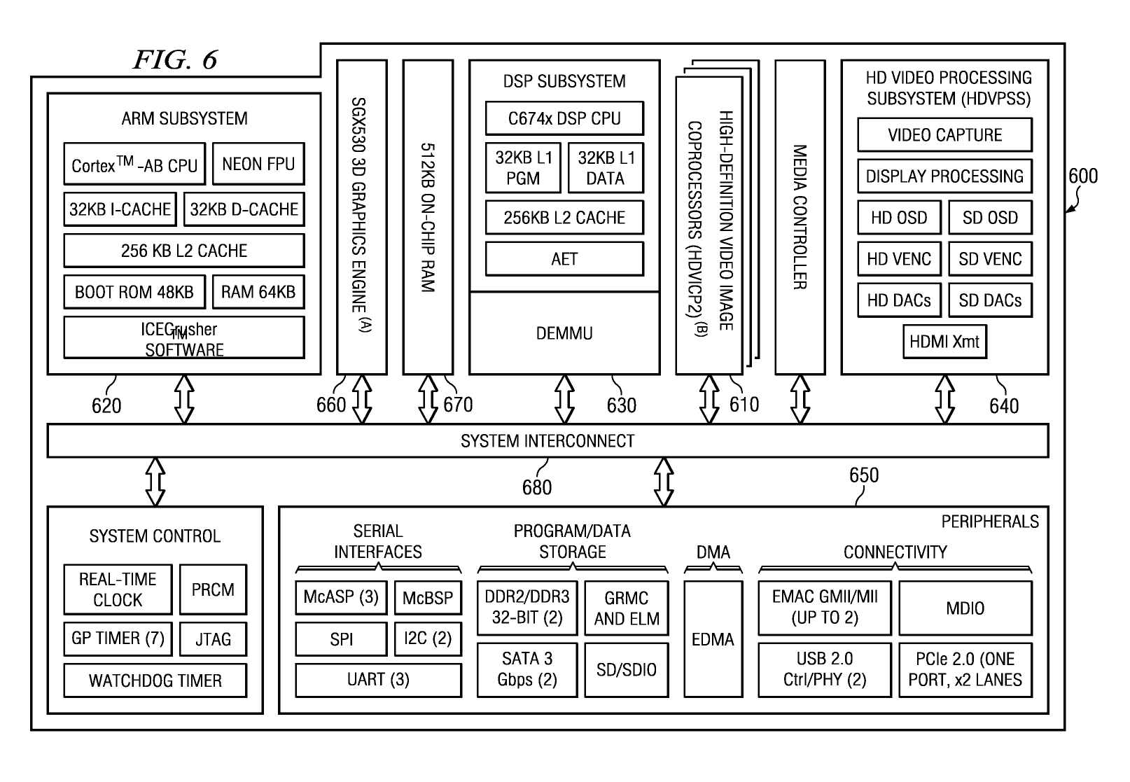

FIG. 6 is a block diagram of an example SoC 600 that may include an embodiment of the invention. This example SoC is representative of one of a family of DaVinci™ Digital Media Processors, available from Texas Instruments, Inc. This example is described in more detail in “TMS320DM816x DaVinci Digital Media Processors, SPRS614”, MARCH 2011 or later and is incorporated by reference herein, and is described briefly below.

The Digital Media Processors (DMP) 600 is a highly-integrated, programmable platform that meets the processing needs of applications such as the following: Video Encode/Decode/Transcode/Transrate, Video Security, Video Conferencing, Video Infrastructure, Media Server, and Digital Signage, etc. DMP 600 may include multiple operating systems support, multiple user interfaces, and high processing performance through the flexibility of a fully integrated mixed processor solution. The device combines multiple processing cores with shared memory for programmable video and audio processing with a highly-integrated peripheral set on common integrated substrate.

DMP 600 may include up to three high-definition video/imaging coprocessors (HDVICP2) 610. Each coprocessor can perform a single 1080p60 H.264 encode or decode or multiple lower resolution or frame rate encodes/decodes. Multichannel HD-to-HD or HD-to-SD transcoding along with multi-coding are also possible.

Programmability is provided by an ARM® Cortex™ A8 RISC CPU 620, TI C674x VLIW floating-point DSP core 630, and high-definition video/imaging coprocessors 610. The ARM® allows developers to keep control functions separate from NV algorithms programmed on the DSP and coprocessors, thus reducing the complexity of the system software. The ARM® Cortex™-A8 32-bit RISC microprocessor with NEON™ floating-point extension includes: 32K bytes (KB) of instruction cache; 32 KB of data cache; 256 KB of L2 cache; 48 KB of Public ROM and 64 KB of RAM.

A rich peripheral set provides the ability to control external peripheral devices and communicate with external processors. The peripheral set includes: HD Video Processing Subsystem (HDVPSS) 640, which provides output of simultaneous HD and SD analog video and dual HD video inputs, and an array of peripherals 650 that may include various combinations of devices, such as: up to two Gigabit Ethernet MACs (10/100/1000 Mbps) with GMII and MDIO interface; two USB ports with integrated 2.0 PHY; PCIe® port x2 lanes GEN2 compliant interface, which allows the device to act as a PCIe® root complex or device endpoint; one 6-channel McASP audio serial port (with DIT mode); two dual-channel McASP audio serial ports (with DIT mode); one McBSP multichannel buffered serial port; three UARTs with IrDA and CIR support; SPI serial interface; SD/SDIO serial interface; two I2C master/slave interfaces; up to 64 General-Purpose I/O (GPIO); seven 32-bit timers; system watchdog timer; dual DDR2/3 SDRAM interface; flexible 8/16-bit asynchronous memory interface; and up to two SATA interfaces for external storage on two disk drives, or more with the use of a port multiplier.

DMP 600 may also include an SGX530 3D graphics engine 660 to enable sophisticated GUIs and compelling user interfaces and interactions. Additionally, DMP 600 has a complete set of development tools for both the ARM and DSP which include C compilers, a DSP assembly optimizer to simplify programming and scheduling, and a Microsoft®Windows®debugger interface for visibility into source code execution.

The C674x DSP core 630 is the high-performance floating-point DSP generation in the TMS320C6000™ DSP platform. The C674x floating-point DSP processor uses 32 KB of L1 program memory and 32 KB of L1 data memory. Up to 32 KB of L1P can be configured as program cache. The remaining is non-cacheable no-wait-state program memory. Up to 32 KB of L1D can be configured as data cache. The remaining is non-cacheable no-wait-state data memory. The DSP has 256 KB of L2 RAM, which can be defined as SRAM, L2 cache, or a combination of both. All C674x L3 and off-chip memory accesses are routed through an MMU.

On-chip shared random access memory (RAM) 670 is accessible by ARM processor 620 and DSP processor 630 via system interconnect 850. System interconnect includes an IPC mechanism for passing messages and initiating interrupts between ARM processor 620 and DSP processor 630.

The device package has been specially engineered with Via Channel™ technology. This technology allows 0.8-mm pitch PCB feature sizes to be used in this 0.65-mm pitch package, and substantially reduces PCB costs. It also allows PCB routing in only two signal layers due to the increased layer efficiency of the Via Channel™ BGA technology.

Applications being executed on ARM processor 620 may access peripherals controlled by DSP processor 630 using a client/host mechanism described herein by building a command structure in shared memory 670 by a client on ARM processor 620 for a service offered by DSP processor 630. The ARM processor 620 and DSP processor 630 both have access to the shared memory 670 via interconnect 680. After the command is built in shared memory 670, the client may request attention from a host process on DSP processor 630 using the IPC mechanism. The host on DSP 630 then decodes the command in shared memory in response to the request for attention. A driver on DSP 630 then performs the service on the according to the command. The client on ARM processor 620 is then notified when the service is complete, as described in more detail above.

Applications executing on DSP 630 may similarly request service by drivers executing on ARM processor 620 using the client/host mechanism described above.

### Other Embodiments

While the invention has been described with reference to illustrative embodiments, this description is not intended to be construed in a limiting sense. Various other embodiments of the invention will be apparent to persons skilled in the art upon reference to this description. Embodiments of the system and methods described herein may be provided on any of several types of digital systems: digital signal processors (DSPs), general purpose programmable processors, application specific circuits (ASIC), or systems on a chip (SoC) such as combinations of a DSP and a reduced instruction set (RISC) processor together with various specialized accelerators. An ASIC or SoC may contain one or more megacells which each include custom designed functional circuits combined with pre-designed functional circuits provided by a design library. DMA engines that support linked list parsing and event triggers may be used for moving blocks of data.

Embodiments of the invention may be used for systems in which multiple monitors are used, such as a computer with two or more monitors. Embodiments of the system may be used for video surveillance systems, conference systems, etc. that may include multiple cameras or other input devices and/or multiple display devices. Embodiments of the invention may be applied to more than two processors in an SoC.

A stored program in an onboard or external (flash EEP) ROM or FRAM may be used to implement aspects of the video processing. Analog-to-digital converters and digital-to-analog converters provide coupling to the real world, modulators and demodulators (plus antennas for air interfaces) can provide coupling for waveform reception of video data being broadcast over the air by satellite, TV stations, cellular networks, etc or via wired networks such as the Internet.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Certain terms are used throughout the description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the previous discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A method for sharing a resource between multiple processors within a single integrated circuit that share a memory, the method comprising:
building a command structure in the shared memory by a client on a first processor for a service offered by a second processor, wherein the first processor and the second processor have access to the shared memory;
requesting attention from the second processor;
decoding the command in shared memory by a host on the second processor in response to the request for attention;
performing the service on the second processor according to the command; and
notifying the client on the first processor when the service is complete.

2. The method of claim 1, wherein requesting attention is performed using an inter-processor communication mechanism.

3. The method of claim 1, wherein notifying the client is performed using the inter-processor communication mechanism.

4. The method of claim 2, wherein using the inter-processor communication mechanism produces an interrupt on the second processor that invokes the host.

5. The method of claim 1, wherein notifying the client is performed by updating a portion of the command structure in shared memory by the host.

6. The method of claim 1, wherein the service is a driver for accessing a peripheral device coupled to the second processor.

7. A system on a chip comprising:
two or more program controlled processors coupled to a shared memory on a common integrated circuit substrate;
an application program and client program stored in memory coupled to a first processor of the two or more program controlled processors for execution by the first processor;
a driver program and a host program stored in memory coupled to a second processor of the two or more program controlled processors for execution by the second processor;
wherein the client program and host program are configured to:
build a command structure in the shared memory by the client on the first processor for a service offered by a the second processor in response to a request for the service by the application program on the first processor,
request attention from the second processor;
decode the command in shared memory by the host program on the second processor in response to the request for attention;
perform the service on the second processor according to the command; and
notify the client on the first processor when the service is complete.

8. The system of claim 7, wherein requesting attention is performed using an inter-processor communication mechanism.

9. The system of claim 8, wherein notifying the client is performed using the inter-processor communication mechanism.

10. The system of claim 8, wherein using the inter-processor communication mechanism produces an interrupt on the second processor that invokes the host program.

11. The system of claim 7, wherein notifying the client is performed by updating a portion of the command structure in shared memory by the host program.

12. The system of claim 7, wherein the service is the driver program for accessing a peripheral device coupled to the second processor.

13. A computer readable media having a client program and a host program stored therein, wherein the client program is configured to be executed by a first processor and the host program is configured to be executed by a second processor, wherein the first processor and the second processor are coupled to a shared memory on a common integrated circuit substrate, wherein the client program and host program are operable to:
build a command structure in the shared memory by the client when executed on the first processor for a service offered by a the second processor in response to a request for the service by an application program executed on the first processor,
request attention from the second processor;
decode the command in shared memory by the host program when executed on the second processor in response to the request for attention;
perform the service on the second processor according to the command; and
notify the client on the first processor when the service is complete.

14. The computer readable media of claim 13, wherein the service is a driver program for accessing a peripheral device coupled to the second processor.

15. The computer readable media of claim 13, wherein requesting attention is performed using an inter-processor communication mechanism between the first processor and the second processor.

16. The computer readable media of claim 15, wherein notifying the client is performed using the inter-processor communication mechanism.

17. The computer readable media of claim 15, wherein using the inter-processor communication mechanism produces an interrupt on the second processor that invokes the host program.

18. The computer readable media of claim 13, wherein notifying the client is performed by updating a portion of the command structure in the shared memory by the host program.
